(19) United States
(12) Patent Application Publication
(10) Pub. No.: US 2011/0124838 A1
(43) Pub. Date: May 26, 2011

(54) METHOD FOR PRODUCTION TONER, TONER, AND METHOD FOR RECYCLING PAPER

(76) Inventors: Akihiro Kotsugai, Shizuoka (JP); Keiko Osaka, Shizuoka (JP); Yoshihiro Moriya, Shizuoka (JP); Shingo Sakashita, Shizuoka (JP); Yukiko Nakajima, Shizuoka (JP); Yoshitaka Yamauchi, Shizuoka (JP); Ryota Inoue, Osaka (JP); Akiyoshi Sabu, Kanagawa (JP); Daiki Yamashita, Tokyo (JP)

(21) Appl. No.: 12/949,418

(22) Filed: Nov. 18, 2010

(30) Foreign Application Priority Data
Nov. 20, 2009 (JP) 2009-265381

(51) Int. Cl. C08G 63/06

(52) U.S. Cl. 528/361

(57) ABSTRACT

The present invention provides a method for producing a toner, which includes 1) saccharifying paper by at least one of a chemical degradation method and a biochemical degradation method to obtain a sugar-containing solution, 2) subjecting the sugar-containing solution obtained through 1) to lactic acid fermentation to obtain a lactic acid, 3) polymerizing the lactic acid obtained through 2) to obtain a polylactic acid, and 4) producing a toner using the polylactic acid obtained through 3).

### BACKGROUND OF THE INVENTION

1. Field of the Invention

The present invention relates to a method for producing a toner for use in forming images through electrophotography, such as a copier, electrostatic printing, a printer, a facsimile, and electrostatic recording, and also relates to a toner and a method for recycling papers.

2. Description of the Related Art

Paper is one of the oldest materials that have continued to be used, and has lots of characteristics that cannot be substituted with any other materials, and is an indispensable material in business operations and daily life. However, in contrast to the demands, there has been a concern in relation with environmental problems, such as reclamation and conversion of natural forest land into artificial forest and the needs of a large amount of heat in the course of production.

There is recording of information as a main application purpose of paper. Regardless of target objects, such as for personal documents, offices, and schools, as purposes for use of a relatively small amount to medium amount of paper, image forming apparatus such as inkjet-type, and electrophotographic type image forming apparatuses are evolving. Especially, electrophotographic image forming method utilizing toner is a method in which a latent electrostatic image (latent image) is formed on a photoconductor, and then the latent image is developed using toner to thereby form a toner image. Such image forming methods utilizing toner cause less deterioration of printed surfaces of media, are excellent in water resistance and in writing properties because of unnecessary of special processing of paper sheets to be used, make it difficult to erase printed images and characters, and the printed matters are excellent in ruggedness. Thus, they are used for a variety of purposes in many fields, for example, not only for general printing purposes, but for creation of important documents and highly confidential documents and for recording information in replacement of silver halide photography.

In the light of utilization of paper, in recent production of paper, recycling of paper is increasingly carried out for the purposes of protecting forest resources, improving the waste paper usage rate, and reducing waste. In production of paper, paper is commonly produced by mixing a virgin pulp obtained from wood and a recycled pulp which is recycled from waste paper, and waste paper accounts for a large percentage of raw materials of paper. In a recycling process of waste paper, printing paper on which some kind of print is provided, undergoes a deinking step and a bleach step to produce a white color pulp again, and the produced pulp is utilized for recycled paper. However, the uses of the recycled paper are actually selected depending on the used history of the paper.

Paper materials for use in writing and printing in offices and schools require writing properties and durability, and thus high-quality paper materials having high content of relatively new pulp are used. Particularly, paper materials for use in electrophotographic type and inkjet type printing require both the applicability to printing and the writing properties and are utilized for storage of documents as printed matters. In most cases, these paper materials are finally disposed of, such as disposing of paper waste by a shredder or by incineration, from the aspects of the use characteristics, confidentiality and privacy. Since waste paper which is shredded into short fibers, such as shredder dust, is shredded to have short fiber lengths, a sufficient strength of paper cannot be obtained even when utilized for recycling and thus it is not suited for utilization to paper materials for writing and printing. Thus, most of these paper materials recycled from waste paper have been used in inexpensive and disposal paper materials, such as fillers, cores for packaging materials and paperboard, and bathroom tissue. Although paper used in offices has a high use rate of new pulp, there is a disadvantage in terms of utilization for recycling.

Most of binder resins accounting for 70% or more of the components of toners for use in printing contain petroleum resources as raw materials, and there are growing concerns about problem with exhaustion of petroleum resources, and global-warming problem caused by consuming a great deal amount of petroleum resources to exhaust carbon dioxide in the air.

Then, when resins derived from plants taking in carbon dioxide in the atmosphere to grow up are used as binder resins, carbon dioxide generated in use of the toners only circulates in the environments, and the use of plant-derived resins may make it possible to solve the global-warming problem and the problem with exhaustion of petroleum resources at a time. A variety of toners using such plant-derived resins as binder resins have been proposed, and it is proposed to use polylactic acid as a binder resin.

For example, as a hydrolyzable and biodegradable electrophotographic toner for which an existing deinking system can be directly used, there has been known an electrophotographic toner using a lactic acid obtainable by lactic acid fermentation of glucose, or a cyclic dimer (lactide) of a lactic acid which can be obtained by reacting a lactic acid aqueous solution in the presence of a tin-based catalyst at 140° C. to 200° C. and subjecting the reaction product to distillation, recrystallization and drying (e.g., using a polylactide resin obtained by ring-opening “LACTY” available from Shimadzu Corporation) (see Japanese Patent Application Laid-Open (JP-A) No. 07-120975). The ring-opening method for obtaining a polylactide resin to be incorporated into a toner for electrostatic developer avoids a complicated process including: oligomerizing a lactic acid once through a dehydration reaction, depolymerizing the reaction product to introduce the resulting product into a cyclic dimer, followed by ring-opening the product. Further, it is known that in this method, in order to avoid the disadvantage that monomer species for copolymerization for use in preferred modification of polylactic acids are limited to cyclic esters, a dehydration-polycondensed product of a lactic acid and a trifunctional or higher polyfunctional oxycarboxylic acid obtained by polycondensation under reduced pressure and application of heat in the presence of a germanium-based catalyst or titanium-based catalyst is used for a toner for electrostatic charge developing, instead of subjecting the lactic acid and trifunctional or more polyfunctional oxycarboxylic acid to ring-opening polymerization (polymerization addition reaction) (see Japanese Patent Application Laid-Open (JP-A) No. 09-274335). In addition, there has been known that as a method for producing a polylactide polymer material, a 85% to 92% aqueous solution of lactic acid is heated in absence of catalyst, finally under the conditions of a temperature of 220° C. to 260° C. and a pressure of 1.4×10³ Pa (10 mmHg) or lower and a polycondensation reaction is completed, to thereby obtain a polylactide having a molecular weight of at least 4,000 (see Japanese Patent Application Laid-Open (JP-A) No. 59-96123). As a method of producing a polylactic acid, there has been known a method in which a lactic acid or an oligomer of lactic acid is subjected to dehydration condensation reaction in an organic solvent in absence of water while an oxidized state of tin in a tin catalyst is maintained at “divalent” to thereby obtain a polylactic acid having a Mw average molecular weight of 15,000 or more (see Japanese Patent Application Laid-Open (JP-A) No. 07-33861). Further, to improve fixability, offset resistance and anti-filming properties when fixing an image at low-temperature, an electrophotographic toner has been disclosed, in which a terpene phenol copolymer is mixed with a polylactic binder resin (see Japanese Patent Application Laid-Open (JP-A) No. 2001-166537).

However, there is no specific description about how a lactic acid as a raw material is obtained in these patent documents. Accordingly, these patent documents do not disclose to use a glucose-containing liquid obtained from paper directly, without removing foreign substances therefrom, as a culture for use in lactic acid fermentation.

Typically, for a method of obtaining a lactic acid which is used as a raw material of a polylactic acid, there are a chemical sensitizing method using acetone as a starting material, and a biochemical production method in which a lactic acid is biochemically produced by fermentation of natural materials such as sugar and starch. At the present time, the latter method is widely used because a material having a relatively high optical purity can be easily obtained.

Japanese Patent Application Laid-Open (JP-A) No. 2008-271826 discloses to produce glucose, in which in a culture containing raw materials including a raw material continuing cellulose as a carbon source (e.g., raw materials such as waste paper, filter paper, general paper, wood materials, wheat straw, rice straw, bran, rice husks, and bagasse) and lactose, product bacterium of specific cellulase belonging to Acremonium species is incubated, and glucose is produced using the produced cellulase. However, the patent document does not disclose to directly use this glucose-containing liquid as a culture for lactic acid fermentation. In addition, Japanese Patent Application Laid-Open (JP-A) No. 2003-135052 discloses a method which includes incubating Acremonium cellulolyticus C1 strain (FERM P-18508) in a culture containing a cellulose raw material and producing glucose using the generated cellulase. However, this patent document does not disclose to directly use the glucose-containing liquid as a culture for lactic acid fermentation.

### BRIEF SUMMARY OF THE INVENTION

The present invention has been made in view of the above circumstances.

That is, the present invention aims to provide a toner production method capable of recycling paper materials that have been utilized once for printing and putting the recycled paper to use as raw materials, a toner, and a method for recycling paper. Also, the present invention aims to provide a toner production method capable of reducing use of petroleum resources and using paper as renewable resources, a toner and a method for recycling paper.

The present inventors carried out extensive studies and examinations to solve the above-mentioned problems. As a result, the present inventors accomplished the present invention.

Means for solving the above-mentioned problems are as follows:

<1> A method for producing a toner, the method including:

1) saccharifying paper by at least one of a chemical degradation method and a biochemical degradation method to obtain a sugar-containing solution,

2) subjecting the sugar-containing solution obtained through 1) to lactic acid fermentation to obtain a lactic acid,

3) polymerizing the lactic acid obtained through 2) to obtain a polylactic acid, and 4) producing a toner using the polylactic acid obtained through 3).

<2> The method for producing a toner according to <1> above, wherein the paper is a paper to which a toner is attached.
<3> The method for producing a toner according to <1> above, wherein the paper is a waste paper.
<4> A toner including:

a polylactic acid,

wherein the toner is produced by the method according to any one of <1> to <3> above.

<5> A method for recycling paper, the method including:

1) saccharifying paper by at least one of a chemical degradation method and a biochemical degradation method to obtain a sugar-containing solution,

2) subjecting the sugar-containing solution obtained through 1) to lactic acid fermentation to obtain a lactic acid,

3) polymerizing the lactic acid obtained through 2) to obtain a polylactic acid, and

4) producing a toner using the polylactic acid obtained through 3).

According to the present invention, it is possible to solve the above-mentioned conventional problems, achieve the above objects and to provide a toner production method capable of recycling paper materials that have been utilized once for printing and putting the recycled paper to use as raw materials, a toner, and a method for recycling paper. Further, according to the present invention, it is possible to provide a toner production method capable of reducing use of petroleum resources and using paper as renewable resources, a toner and a method for recycling paper.

### DETAILED DESCRIPTION OF THE INVENTION

### Method for Producing Toner

A method for producing a toner according to the present invention includes at least a saccharification step, a lactic acid fermentation step, a polymerization step and a toner production step and further includes other steps suitably selected according to the necessity.

### <Saccharification Step>

The saccharification step is a step of saccharifying paper by at least one of a chemical degradation method and a biochemical degradation method to obtain a sugar-containing solution.

The paper is not particularly limited, as long as it contains, as a raw material, at least one of a virgin pulp obtained from wood and a recycled pulp obtained by recycling waste paper, and may be suitably selected in accordance with the intended use. Examples thereof include paper for use in offices, printed matters and waste paper. These papers may be those to which toner is attached, and may be papers, such as waste paper which has been shredded into short fibers by a shredder or the like. The main components of the papers are cellulose, hemicellulose, lignin, and minerals, as additives. Of these components, by hydrolysis of cellulose, glucose, which is a monosaccharide, can be obtained. As the hydrolyzing method to obtain glucose, a known method can be used.

The method of saccharifying paper is not particularly limited and may be suitably used in accordance with the intended use. For example, there may be exemplified chemical degradation methods (e.g. a method of directly hydrolyzing paper with a strong acid such as a sulfuric acid, a nitric acid or the like; a method of directly hydrolyzing paper with various solid acids such as an ion exchanged resin; a hydrolyzing method by mixing with a strong base such as NaOH, KOH, etc.; and a method of using a metal catalyst supported by metal such as Pt, Ru, Ni, Rh, Pd, and Ir.); and biochemical degradation methods such as a cellulase method using a combination of enzymes called “cellulase” in which a cellulose such as endo-β-glucanase (which is also referred to as “Cx enzyme” or “CMCase”), exo-β-glucanase (which is also referred to as “C₁ enzyme”, “Avicelase”, “cellobiohydrolase”, or “FPase”), and β-glucosidase (which is also referred to as “cerebrosidase”) is hydrolyzed to give cellobiose, cellooligotose and finally to give glucose. Among these methods, the cellulase method is preferable in that paper can be efficiently degraded to a monosaccharide. In other words, cellulose, which is a main component of paper, contains an extremely large amount of xylan moieties of β-1,4 bond producing glucose through hydrolysis. However, cellulose contains not only the moieties but also branched moieties in which a hexose moiety is condensed with a hydroxy group at position 2 of another hexose moiety and the chain structure is branched into two paths, also has mannan moieties and glucosan moieties, and further has not only the hexose moieties but also pentose moieties, and a slight amount of lignin, pectin, lipid and resin constituents can survive. Thus, cellulose may contain, as active ingredients, enzymes that selectively hydrolyze these components. This method is suitable for the subsequent lactic acid fermentation step because the degradation conditions are mild, and there is less affect from by-products.

Further, as the method of saccharifying paper, it is also possible to use a method of degrading cellulose in supercritical water (hydrothermal method).

The hydrothermal method is a method for hydrolyzing cellulose, utilizing an action of water in which cellulose is left in a supercritical state (at a temperature of 374° C. and at a barometric pressure of 221), and water acts as a bronsted acid.

Further, the hydrothermal conditions are fierce with supercritical conditions, and glucose is degraded in excess, and thus a subcritical state, which is milder than supercritical state (in a state where one of the temperature and the pressure will not reach a supercritical temperature or a supercritical pressure) is utilized as the first step of hydrolysis conditions, and then this may be combined with the above-mentioned biochemical degradation method or chemical degradation method. These methods may be used singularly or in combination.

Meanwhile, paper that has undergone a papermaking process once has relatively low crystallinity of cellulose, particularly in white paper for use in offices, removal of lignin is sufficiently performed, and thus it can be degraded under mild conditions. More specifically, paper which is shredded, preferably finely shredded, can be saccharified with a certain degree of yield by pressuring and heating in the presence of water, or by using directly an enzyme method.

By saccharifying paper through the above method, a sugar-containing solution which contains as a main component glucose, which is a C6 sugar, can be obtained (in the case of paper). Besides glucose, xylose as C5 sugar, other sugars, disaccharides thereof, sugar alcohol, a short-chain carboxylic acid (e.g., by-produced acetic acid as excess degraded product) and alcohol can be incorporated into this sugar-containing solution.

### <Lactic Acid Fermentation Step>

The lactic acid fermentation step is a step of obtaining a lactic acid by lactic acid fermentation of the sugar-containing aqueous solution obtained through the saccharification step.

As the sugar-containing solution, the sugar-containing solution obtained through the saccharification step may be used directly or a glucose solution obtained by purification of the sugar-containing solution may be used.

The method of lactic acid fermentation is not particularly limited and may be suitably selected from among known methods in accordance with the intended use. For example, methods of incubating lactobacillus such as Lactobacillus species, Bifidobacterium species, Enterococcus species, Lactococcus species, Pediococcus species, and Leuconostoc species, using the above-obtained sugar-containing aqueous solution as a culture medium, to be subjected to aerobic fermentation.

The fermentation of the aqueous solution is continued while the temperature and the pH of the sugar-containing aqueous solution are appropriately controlled and, if necessary, while active lactobacillus is added thereto. At this time, a suitable nitrogen source is mixed in the culture medium. In the course of fermentation, the pH of the system is inclined to acidic by a lactic acid to be produced, and thus it is preferable to perform the lactic acid fermentation while suitably neutralizing the system. As a base for use in the neutralization, a carbonate, acetate, lactate etc. of alkali metal are preferable.

### <Polymerization Step>

The polymerization step is a step of polymerizing the lactic acid obtained through the lactic acid fermentation to obtain a polylactic acid.

As the lactic acid, the lactic acid-containing solution obtained through the lactic acid fermentation may be used directly, or a lactic acid obtained by separation/purification of the lactic acid-containing solution may be used.

The method of polymerization the lactic acid is not particularly limited and may be suitably selected from among known methods in accordance with the intended use. For example, there may be exemplified a method in which a polylactic acid aqueous solution is directly dehydrated and condensed in the presence of an appropriate catalyst while being dehydrated under reduced pressure and under application of heat; and a lactide method in which a low-molecular weight polylactic acid is once produced, and the polylactic acid is depolymerized to obtain a lactide, which is a dimeric cyclic ester, and the lactide is ring-opening polymerized.

Lactic acids include an L-lactic acid and a D-lactic acid which are optical isomers. In the present invention, the polylactic acid is preferably an amorphous polylactic acid which is obtainable by polymerizing a combination of an L-lactic acid and a D-lactic acid.

This is because, in order to obtain thermal properties required for a toner, i.e., in order to heat-fuse the toner at an appropriate temperature in a heat fixing method, a polylactic acid, which is inherently crystalline, is partially amorphousized before being used. In the present invention, as a content ratio of an L-lactic acid and a D-lactic acid, one of them is preferably used in an excessive amount, and from the viewpoint of cost efficiency, it is more preferable to use the D-lactic acid in a less amount.

The glass transition temperature of the polylactic acid is not particularly limited and may be suitably selected in accordance with the intended use. It is, however, preferably from 40° C. to 62° C., more preferably from 45° C. to 62° C. To obtain such a polylactic acid, the content ratio of an L-lactic acid and a D-lactic acid in the polylactic acid can be arbitrarily selected in the range of from 5:95 to 95:5. Within this range, when the amount of an L-lactic is excessively high, the content rate is preferably 80:20 to 95:5, and when the amount of a D-lactic is excessively high, the content rate is preferably 5:95 to 20:80.

Examples of the method of blending an L-lactic acid and a D-lactic acid include a method of mixing a lactic aqueous solution whose optical purity is clearly known is mixed with a D-lactic acid beforehand. In the case of employing a lactide method, it may be a method of using an L-lactide and a D-lactide in a desired mixture ratio, or a method of mixing a meso-lactide with an L-lactide or a D-lactide.

As the polylactic acid, it is also possible to use a resin having, at a part of its structure, a polylactic acid which is obtained by incorporating a hydroxy acid, a polyhydric alcohol, a polyvalent fatty acid or the like into a lactic acid so as to be co-condensation-polymerized.

As the catalyst, octylic acid tin may be exemplified as the most typical example, however, it may be any other materials having catalytic activity.

As the method of polymerizing a lactic acid, it is also possible to use an ester synthesis reaction catalyzed by hydrolase. The hydrolase may be suitably selected without any restriction, as long as it is capable of catalyzing an ester synthesis reaction. Examples of the hydrolase include esterases belonging to EC (enzyme number) 3.1 group (refer to “Enzyme Handbook”, published by Maruo and Tamiya, published by Asakura Publishing Co. in 1982) such as carboxy esterase, lipase, phospholipase, acetylesterase, pectinesterase, cholesterol esterase, tannase, monoacylglycerol lipase, lactonase, and lipoprotein lipase; hydrolases such as glucosidase, galactosidase, glucuronidase and xylosidase belonging to EC 3.2 group which acts on glycosyl compounds; hydrolases such as epoxide hydrase belonging to EC 3.3 group; hydrolases such as aminopeptidase, chymotrypsin, trypsin, plasmin and subtilisin belonging to EC 3.4 group which act s on peptide bond, and hydrolases such as phloretin hydrolase belonging to EC 3.7 group.

Among the above-described esterases, enzymes which hydrolyze a glycerol ester to liberate a fatty acid are called “lipase”. Lipase has advantages in that it catalyzes an ester synthesis reaction with high a high yield and is available at a low cost.

Among the above-described esterases, it is therefore preferred to use lipase from the above viewpoints.

As the lipase, lipases of various origins are usable without any restriction, but preferred examples thereof include lipase available from microorganisms including Pseudomonas species, Alcaligenes species, Achromobacter species, Candida species, Aspergillus species, Rhizopus species, and Mucor species, lipase available from seeds of plants, and lipase available from the tissue of animals, pancreatin and steapsin.

Among these lipases, it is more preferable to use lipases derived from microorganisms of Pseudomonas, Candida and Aspergillus species.

The hydrolases may be used alone or in combination. Further, to stabilize the enzyme and to readily collect a reaction product, an enzyme that has been solidified by a known method may be used.

The addition amount of the hydrolase is not particularly limited and may be suitably selected in accordance with the intended use. It is, however, preferably 1 g or more per mole of the cyclic compound which is a monomer.

The reaction temperature and the reaction time for the ester synthesis reaction catalyzed by the hydrolase are not particularly limited and may be suitably selected in accordance with the intended use. The reaction temperature is, however, preferably from 50° C. to 150° C., and the reaction time is preferably 2 hours or longer.

### <Toner Production Step>

The toner production step is a step of producing a toner using the polylactic acid obtained through the polymerization step.

The toner contains at least a colorant, a lactic acid serving as a thermoplastic resin, which is obtained through the polymerization step, and, if necessary, further contains other components other resins, a releasing agent, a charge controlling agent.

The toner can be obtained by granulating a toner composition containing at least a colorant, and a lactic acid serving as a thermoplastic resin, which is obtained through the polymerization step, by a known method.

The method of mixing the colorant is not particularly limited and may be suitably selected in accordance with the intended use. However, a colorant masterbatch is preferably used. In this case, any method may be used, such as a melt-kneading method, and a dispersing method in which a colorant is melted in an oil-based liquid and dispersed under application of a mechanical, and flowing shearing force.

The colorant is not particularly limited and may be suitably selected in accordance with the intended use. At least one colorant selected from, for example, colorants for black, colorants for cyan, colorants for magenta, and colorants for yellow, may be used. Toners for individual color, can be suitably selected depending on the type of the colorants, however, preferably color toners.

Examples of the colorants for black include carbon black (C.I. Pigment Black 7) such as furnace black, lamp black, acetylene black, and channel black; metals such as copper, iron (C.I. Pigment Black 11), and titanium oxides; and organic pigments such as aniline black (C.I. Pigment Black 1).

Examples of the colorants for magenta include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209, 211, and 286; C.I. Pigment Violet 19; C.I. Bat Red 1, 2, 10, 13, 15, 23, 29, and 35.

Examples of the colorants for cyan include C.I. Pigment Blue 2, 3, 15, 15:1, 15:2, 15:3, 15:4, 15:6, 16, 17, and 60; C.I. Bat Blue 6; C.I. Acid Blue 45, a copper phthalocyanine pigment having 1 to 5 phthalimide methyl groups substituted on the phthalocyanine skeleton, Green 7, and Green 36.

Examples of the colorants for yellow include C.I. Pigment Yellow 0-16, 1, 2, 3, 4, 5, 6, 7, 10, 11, 12, 13, 14, 15, 16, 17, 23, 55, 65, 73, 74, 83, 97, 110, 151, 154, and 180; C.I. Bat Yellow 1, 3, and 20, and Orange 36.

The amount of the colorant in the toner is not particularly limited and may be suitably selected in accordance with the intended use. It is however, preferably 1% by mass to 15% by mass, more preferably 3% by mass to 10% by mass.

When the colorant content is less than 1% by mass, the coloring power of the toner may be decreased. When the colorant content is more than 15% by mass, a dispersion defect of the pigment may occur in the toner, which may cause a decrease in the coloring power and a decrease in the electric property of the toner.

As the method of mixing and dispersing the colorant to form a toner product, any method can be employed, such as a method in which at least a colorant and the polylactic acid obtained through the polymerization step is heat-kneaded by a common heat kneader, a roll kneader, a continuous kneader having a single axis or plural axes; a method in which a colorant and the polylactic acid obtained through the polymerization step are dispersed in a granular state in a fluid medium such as an aqueous medium, and then made to aggregate and coalesce; a method in which a colorant and the polylactic acid obtained through the polymerization step are dissolved again in styrene, vinyl monomer or the like, and then polymerized in a non-aqueous solvent; and a method in which a colorant and the polylactic acid obtained through the polymerization step are dissolved in an appropriate solvent, and then dispersed in a non-aqueous medium such as water.

The method of obtaining toner particles, it is possible to use a method of pulverizing and size-selecting the resin obtained above using a known pulverizer, and various chemical toner production methods, but the method is not limited thereto.

### —Other Components—

### ——Charge Controlling Agent——

When necessary, a charge controlling agent may also be incorporated into the toner composition for imparting appropriate chargeability to the toner.

The method of introducing the charge controlling agent is not particularly limited and may be suitably selected in accordance with the intended use. Examples of the introducing method include a method of kneading and dispersing a charge controlling agent into a toner composition; in the case of a chemical toner, such as a toner produced by suspension polymerization, a method in which a charge controlling agent is dispersed or dissolved in a solvent or monomer droplets, a method in which a charge controlling agent dispersed in water is made to aggregate and coalesce in toner particles so as to be introduced thereto, and a method of chemically adding a charge controlling agent on surfaces of toner particles after production of the toner particles.

As the charge controlling agent, any known charge controlling agents may be used.

Since a colored material is used, the resulting toner may change its color tone, materials almost colorless or white are preferably used. Specific examples of the charge controlling agent include known charge controlling agents such as triphenylmethane dyes, chelate compounds of molybdic acid, Rhodamine dyes, alkoxy amines, quaternary ammonium salts (including fluorine-modified quaternary ammonium salts), alkylamides, phosphor or compounds including phosphor, tungsten or compounds including tungsten, fluorine-containing activators, metal salts of salicylic acid, and salicylic acid derivatives. These may be used alone or in combination.

Specific examples of commercially available products of the charge controlling agents include BONTRON P-51 (quaternary ammonium salt), E-82 (metal complex of oxynaphthoic acid), E-84 (metal complex of salicylic acid), and E-89 (phenolic condensation product), which are produced by Orient Chemical Industries Co., Ltd.; TP-302 and TP-415 (molybdenum complex of quaternary ammonium salt), which are produced by Hodogaya Chemical Co., Ltd.; COPY CHARGE PSY VP2038 (quaternary ammonium salt), COPY BLUE PR (triphenyl methane derivative), COPY CHARGE NEG VP2036 and NX VP434 (quaternary ammonium salts), which are produced by Hoechst AG; LRA-901, and LR-147 (boron complex), which are produced by Japan Carlit Co., Ltd.; quinacridone, azo pigments and polymer compounds having a functional group such as a sulfonate group, a carboxyl group, a quaternary ammonium group, etc. Among these, fluorine-containing quaternary ammonium salt is more preferable.

The amount of the charge controlling agent is determined depending on the species of the binder resin used, whether or not an additive is added and toner production method (such as dispersion method) used, and is not unequivocally defined. However, for example, the amount of the charge controlling agent is preferably from 0.1 parts by mass to 10 parts by mass, and more preferably from 0.2 parts by mass to 5 parts by mass, per 100 parts by mass of the binder resin contained in the toner. When the amount of the charge controlling agent is less than 0.1 parts by mass, the charge controllability may not be obtained, and when the amount of the charge controlling agent is more than 10 parts by mass, the toner has too large chargeability, and thereby the electrostatic force of a developing roller attracting the toner increases, resulting in degradation of the flowability of the toner and decrease of the image density of toner images.

### ——Releasing Agent——

Further, the toner may contain a releasing agent (wax) as required.

The method of introducing the releasing agent is not particularly limited and may be suitably selected in accordance with the intended use. Examples of the introducing method include a method of kneading and dispersing a releasing agent into a toner composition; in the case of a chemical toner, such as a toner produced by suspension polymerization, a method in which a releasing agent is dispersed or dissolved in a solvent or monomer droplets, a method in which a releasing agent dispersed in water is made to aggregate and coalesce in toner particles so as to be introduced thereto, and a method of chemically adding a releasing agent on surfaces of toner particles after production of the toner particles.

The releasing agent is not particularly limited and may be suitably selected in accordance with the intended use. Examples of the releasing agent include aliphatic hydrocarbon waxes (e.g. low-molecular-weight polyethylene, low-molecular-weight polypropylene, polyolefin wax, microcrystalline wax, paraffin wax, SASOL wax), oxides of aliphatic hydrocarbon waxes (e.g. polyethylene oxide wax) and block copolymers thereof, plant waxes (e.g. candelilla wax, carnauba wax, haze wax, jojoba wax), animal waxes (e.g. bees wax, lanoline, spermaceti wax), mineral waxes (e.g. ozokerite, ceresin, petrolatum), waxes including fatty acid esters (e.g. montanic acid ester wax, castor wax) as a main component, and partially or completely deacidified fatty acid esters (e.g. deacidified carnauba wax).

In addition, as the releasing agent, the following compounds can also be used: saturated straight-chain fatty acids (e.g. palmitic acid, stearic acid, montanic acid, and other straight-chain alkyl carboxylic acid), unsaturated fatty acids (e.g. brassidic acid, eleostearic acid, parinaric acid), saturated alcohols (e.g. stearyl alcohol, eicosyl alcohol, behenyl alcohol, carnaubyl alcohol, ceryl alcohol, melissyl alcohol, and other long-chain alkyl alcohol), polyols (e.g. sorbitol), fatty acid amides (e.g. linoleic acid amide, olefin acid amide, lauric acid amide), saturated fatty acid bisamides (e.g. methylenebis capric acid amide, ethylenebis lauric acid amide, hexamethylenebis capric acid amide), unsaturated fatty acid amides (e.g. ethylenebis oleic acid amide, hexamethylenebis oleic acid amide, N,N′-dioleyl adipic acid amide, N,N′-dioleyl sebacic acid amide), aromatic bisamides (e.g. m-xylenebis stearic acid amide, N,N-distearyl isophthalic acid amide), metal salts of fatty acids (e.g. calcium stearate, calcium laurate, zinc stearate, magnesium stearate), aliphatic hydrocarbon waxes to which a vinyl monomer such as styrene and an acrylic acid is grafted, partial ester compounds between a fatty acid such as behenic acid monoglyceride and a polyol, and methyl ester compounds having a hydroxyl group obtained by hydrogenating plant fats.

As the releasing agent, the following compounds can also be used: a polyolefin obtained by radical polymerizing an olefin under high pressure; a polyolefin obtained by purifying low-molecular-weight by-products of a polymerization reaction of a high-molecular-weight polyolefin; a polyolefin polymerized under low pressure in the presence of a Ziegler catalyst or a metallocene catalyst; a polyolefin polymerized using radiation, electromagnetic wave, or light; a low-molecular-weight polyolefin obtained by thermally decomposing a high-molecular-weight polyolefin; paraffin wax; microcrystalline wax; Fischer-Tropsch wax; synthesized hydrocarbon waxes obtained by synthol method, hydrocoal method, or Arge method; synthesized waxes containing a compound having one carbon atom as a monomer unit; hydrocarbon waxes having a functional group such as hydroxyl group and carboxyl group; mixtures of a hydrocarbon wax and that having a functional group; and these waxes to which a vinyl monomer such as styrene, a maleate, an acrylate, a methacrylate, and a maleic anhydride is grafted.

In addition, these waxes subjected to a press sweating method, a solvent method, a recrystallization method, a vacuum distillation method, a supercritical gas extraction method, or a solution crystallization method, so as to much more narrow the molecular weight distribution thereof are preferably used. Further, low-molecular-weight solid fatty acids, low-molecular-weight solid alcohols, low-molecular-weight solid compounds, and other compounds from which impurities are removed are preferably used.

Among the releasing agents described above, carnauba waxes are even more preferable because it exhibits the best dispersibility with respect to the binder resin for use in the present invention. Among the carnauba waxes, a carnauba wax from which free fatty acids are desorbed are particularly preferable.

The melting point of the releasing agent is preferably from 60° C. to 120° C., and more preferably from 70° C. to 110° C., for the purpose of balancing the fixability and the offset resistance. When the melting point is lower than 60° C., the blocking resistance may degrade, and when it is higher than 120° C., the effect of offset resistance may be hardly exhibited.

Further, by using two or more different type releasing agents in combination, the plasticizing action, which is an action of the releasing agent, and the releasing action can be simultaneously exhibited.

Examples of releasing agent having a plasticizing action include waxes having a low melting point, releasing agents having a branched molecular structure, and releasing agents having a polar group.

Examples of releasing agent having a releasing action include waxes having a high melting point. As a molecular structure thereof, those having a straight chain structure, compounds of nonpolar type which have no functional group are exemplified.

Use examples of the releasing agent include a combination of two or more different type releasing agents having a difference in melting point of from 10° C. to 100° C., and a combination of a polyolefine with a graft-modified polyolefine.

When two types of releasing agent are selected and they have a similar structure, a wax having a relatively low melting point exhibits the plasticizing action, and a releasing agent having a higher melting point exhibits the releasing action. At this time, when the difference in melting point is from 10° C. to 100° C., the functional separation is effectively exhibited. When the difference in melting point is lower than 10° C., the functional separation may be hardly exhibited, and when the difference in melting point is higher than 100° C., the functions brought by the interaction may be hardly intensified. At this time, the melting point of at least one releasing agent of them is preferably from 60° C. to 120° C., and more preferably from 70° C. to 110° C.

Concerning the releasing agent, those having a branched structure, those having a polar group like functional group, and those modified with a component different from the main component exhibit the plasticizing action, and those having a straight chain structure, nonpolar ones having no functional group, and unmodified ones exhibit the releasing action.

Examples of preferred combinations of releasing agents include a combination of a polyethylene homopolymer or copolymer containing ethylene as the main component and a polyolefine homopolymer or copolymer containing olefin other than ethylene; a combination of a polyolefine and a graft-modified polyolefine; a combination of alcohol wax, a fatty acid wax or ester wax, and a hydrocarbon wax; a combination of Fischer-Tropsch wax or polyolefine wax and paraffin wax or microcrystalline wax; a combination of Fischer-Tropsch wax and a polyolefine wax; a combination of paraffin wax and microcrystalline wax; a combination of carnauba wax, candelilla wax, rice wax or montan wax and a hydrocarbon wax.

In any of these combinations, for easily balancing the toner storage stability and the fixability, in endothermic peaks obtained in a DSC measurement of toner, the endothermic maximum peak temperature of the wax is preferably in the range of 60° C. to 120° C., and more preferably in the range of 70° C. to 110° C.

In the present invention, the peak top temperature of the endothermic maximum peak of the releasing agent (wax) measured by DSC is regarded as the melting point of the releasing agent, and this melting point is preferably from 60° C. to 120° C.

Here, the melting point was determined from a DSC curve which was measured using a differential scanning calorimeter (manufactured by Shimadzu Corporation, TA-60WS, and DSC-60) as a DSC measurement device for the releasing agent or toner.

The measurement was carried out according to ASTM D3418-82.

As a DSC curve for use in the present invention, after the temperature of the releasing agent or toner was raised once and then decreased to take a pre-history, a value obtained when the temperature thereof was razed at a temperature increase rate of 10° C./min was used.

The total amount of the releasing agent is preferably 0.2 parts by mass to 30 parts by mass, more preferably 1 part by mass to 15 parts by mass, and still more preferably 3 parts by mass to 10 parts by mass, per 100 parts by mass of the binder resin.

### ——External Additives——

Various additives may be added to the toner of the present invention, in view to improving the flowability, and controlling the chargeability and the electric properties of the toner.

The external additives are not particularly limited and may be suitably selected from among known external additives. Examples thereof include silica fine particles, hydrophobized silica fine particles, fatty acid metal salts (e.g., zinc stearate, and aluminum stearate); metal oxides (e.g., titanium, alumina, tine oxide, and antimony oxide) or hydrophobized products thereof, and fluoropolymers. Among these, hydrophobized silica fine particles, titanium particles, and hydrophobized titanium fine particles are particularly preferable.

Specific examples of the silica fine particles include HDK H2000, HDK H2000/4, HDK H2050EP, HVK21, and HDK H1303 (all produced by Hoechst AG); and R972, R974, RX200, RY200, R202, R805, and R812 (all produced by Nippon Aerosil Co., Ltd.).

Specific examples of the titanium fine particles include P-25 (produced by Nippon Aerosil Co., Ltd.); STT-30, and STT-65C-S (produced by Titan Kogyo Ltd.); TAF-140 (produced by Fuji Titanium Industry Co., Ltd.); and MT-150W, MT-500B, MT-600B, and MT-150A (all produced by TAYCA CORPORATION).

Specific examples of the hydrophobized titanium oxide fine particles include T-805 (produced by Nippon Aerosil Co., Ltd.); STT-30A, and STT-655-S (produced by Titan Kogyo Ltd.); TAF-500T, and TAF-1500T (produced by Fuji Titanium Industry Co., Ltd.); MT-100S, and MT-100T (produced by TAYCA CORPORATION); and IT-S (produced by ISHIHARA SANGYO KAISHA LTD.).

The hydrophobized silica fine particles, hydrophobized titanium fine particles, and hydrophobized alumina fine particles can be obtained by subjecting hydrophilic fine particles to hydrophobization treatment with a silane coupling agent such as methyltrimethoxysilane, methyltriethoxysilane, and octyltrimethoxysilane.

Examples of the hydrophobizing agent include silane coupling agents (e.g., dialkyl dihalogenated silane, trialkyl halogenated silane, and alkyl trihalogenated silane; silylation agent, silane coupling agents having an alkyl fluoride group, organic titanate-based coupling agents, aluminum-based coupling agents, silicone oil, and silicone varnish.

In addition, silicone oil inorganic fine particles are also preferably used. Such silicone oil inorganic fine particles are obtained by treating inorganic fine particles with silicone oil, if necessary under application of heat.

Specific examples of the inorganic particles include silica, alumina, titanium oxide, barium titanate, magnesium titanate, calcium titanate, strontium titanate, iron oxide, copper oxide, zinc oxide, tin oxide, silica sand, clay, mica, wollastonite, diatom earth, chromium oxide, cerium oxide, colcothar, antimony trioxide, magnesium oxide, zirconium oxide, barium sulfate, barium carbonate, calcium carbonate, silicon carbide, and silicon nitride. Among these, silica, and titanium dioxide are particularly preferable.

Examples of the silicone oil include dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxy-modified silicone oil, mercapto-modified silicone oil, acrylic or methacrylic-modified silicone, α-methylstyrene-modified silicone oil.

The average particle diameter of primary particles of the inorganic fine particles is preferably from 1 nm to 100 nm, more preferably from 3 nm to 70 nm. When the average particle diameter is smaller than 1 nm, the inorganic fine particles are embedded in the toner, and it may be difficult for the inorganic fine particles to exhibit the function. When the average particle diameter is greater than 100 nm, the inorganic fine particles may unevenly hurt the surface of a latent electrostatic image bearing member.

As the external additives, inorganic fine particles and hydrophobized fine particles can be used in combination, however, the average particle diameter of hydrophobized primary particles is preferably 1 nm to 100 nm, more preferably 5 nm to 70 nm.

In addition, the toner of the present invention preferably contains at least two kinds of inorganic fine particles having an average particle diameter (hydrophobized primary particles) of 20 nm or smaller, and more preferably, contains at least one kind of inorganic fine particles having an average particle diameter (hydrophobized primary particles) of 30 nm or greater, in addition to at least two kinds of the inorganic fine particles.

The specific surface of the inorganic fine particles measured by a BET method is preferably 20 m²/g to 500 m²/g.

The amount of the external additives added to the toner is preferably 0.1% by mass to 5% by mass, and more preferably 0.3% by mass to 3% by mass.

As the external additives, resin fine particles can also be added to the toner.

Examples of the resin fine particles include polystyrene obtained by soap-free emulsification polymerization, suspension polymerization, or dispersion polymerization; copolymers of methacrylic acid ester or acrylic acid ester; polycondensates of silicone, benzoguanamine, nylon, etc.; and polymer particles made of thermocurable resins.

By using such resin fine particles in combination, it is possible to enhance the chargeability of toner, to reduce the amount of oppositely charged toner and to reduce the occurrence of background smear.

The amount of the resin fine particles added to the toner is preferably 0.01% by mass to 5% by mass, and more preferably 0.1% by mass to 2% by mass.

The toner may contain other components, as required, for example, a flowability improver, a cleanability improver, a magnetic material, and metal soap.

The flowability improver is used in surface treatment for improving hydrophobicity and capable of preventing degradation of flowability and chargeability even under high-humidity conditions. Examples thereof include silane coupling agents, silylation agents, silane coupling agents having an alkyl fluoride group, organic titanate-based coupling agents, aluminum-based coupling agents, silicone oil, and modified silicone oil.

The cleanability improver is added into the toner for removing a developer remaining on a latent electrostatic image bearing member and an intermediate transfer member after image transfer. Examples of the cleanability improver include fatty acid metal salts (e.g., zinc stearate, calcium stearate, and stearic acid); and polymer fine particles produced by soap-free emulsification polymerization (e.g., polymethyl methacrylate fine particles, and polystyrene fine particles).

As the polymer fine particles, those having a relatively narrow particle size distribution and a volume average particle diameter of 0.01 μm to 1 μm are preferable.

The magnetic materials are not particularly limited and may be suitably selected from among known materials in accordance with the intended use. Examples thereof include iron powder, magnetite, and ferrite. Among these, white ones are preferable in terms of color tone.

### EXAMPLES

Hereinafter, the present invention will be described with reference to Examples of the present invention, which however shall not be construed as limiting the scope of the present invention.

### Example 1

### 1. Hydrolysis of Waste Paper

Paper on which a toner has been printed was shredded by a shredder, water (90 parts by mass) was added to the paper (10 parts by mass), and this was further splintered by a sand mill to obtain a slurry. The pH of the thusly obtained slurry was adjusted with NaOH to be pH 3, and the slurry was heated and stirred in an autoclave at 150° C. for 1 hour, under application of a pressure of 1.6×10⁵ Pa (1200 torr). After the temperature and the pressure of the autoclave were returned to a reduced pressure and normal temperature, the resulting slurry was neutralized with HCl so as to have a pH of about 7.

Further, sodium lactate (1 part by mass), a cellulase enzyme (0.1 parts by mass) (Cellulase Y-C, produced by Kokusan Chemical Co., Ltd.) was added to the resulting slurry, and the slurry was saccharified for 3 days while the temperature thereof being maintained at 40° C. and the pH being adjusted to be in the range of 5 to 8 using an acetic acid and an NaOH aqueous solution, while being stirred to thereby obtain a sugar-containing solution as an enzymolysis liquid of paper and printed matter.

The glucose concentration of the sugar-containing solution was determined and found to be 48% by mass.

### 2. Lactic Acid Fermentation of Sugar

The sugar-containing solution obtained through <1. Hydrolysis of Waste Paper> was filtered to remove residues therefrom. Then, calcium carbonate (15 parts by mass), a yeast-extracted product (65% by mass) (5 parts by mass), and an incubated active Bacillus coagulance were added to the obtained sugar-containing solution (100 parts by mass) as a culture, and the slurry was subjected to aerobic lactic acid fermentation for 3 days while the pH being maintained in the range of 5 to 8, the temperature being maintained at 35° C., and being stirred.

Solid matters were removed from the resulting fermented liquid by centrifugal separation, and a sulfuric acid liquid was added dropwise in the fermented liquid under stirring until precipitates were not observed.

The resulting slurry was again subjected to centrifugal separation to remove solid matters therefrom and then concentrated by an evaporator to thereby obtain an aqueous solution containing a lactic acid.

The obtained aqueous solution was subjected to a measurement using an optical resolution column (SUMICHRAL OA) and HPLC, and it was found that the aqueous solution is a lactic acid aqueous solution in which the ratio of L-lactic acid to D-lactic acid was 91:9, and the lactic acid content was 42% by mass.

### 3. Production of Polylactic Acid Resin

The lactic acid aqueous solution obtained through <2. Lactic acid fermentation of Sugar> (100 parts by mass) was poured into a glass container equipped with a distillation tube, and a device capable of deaerating, and further a D-lactic acid aqueous solution was added so that the ratio of L-lactic acid to D-lactic acid was 85:15 and the lactic acid content was 40% by mass. This aqueous solution was distilled at 80° C., and when the lactic acid content had exceeded 90% by mass, the system was further heated to distil water completely. After the pressure of the system was reduced to 4.0×10³ Pa (30 torr) and the system was heated at 150° C. for 2 hours, tin chloride dissolved in toluene (0.1 parts by mass) and a p-toluenesulfonic acid (0.1 parts by mass) were added dropwise to the lactic acid (100 parts by mass), and deaeration and heating were continued. The temperature of the device was raised to 160° C., and polymerization reaction proceeded while reducing the pressure to 1.3×10³ Pa (10 torr). After the reaction for 5 hours, a polylactic acid resin having a Mw of 17,000 was obtained.

A dissolved liquid of this polylactic acid resin was put in the form of strand on a Teflon (registered) plate.

This product was dried in a decompression device at normal temperature and a pressure of 4.0×10³ Pa (30 torr) for 6 hours to thereby obtain a Resin A.

### 4. Washing of Polylactic Acid Resin

Resin A obtained through <3. Production of Polylactic Acid Resin> (10 parts by mass) was dissolved in ethyl acetate (30 parts by mass), and the solution was added dropwise into methanol (3,000 parts by mass) while being stirred. A white colored resin was precipitated in the methanol, and this resin was separated from the methanol and put on a Teflon (registered) plate. This product was dried in a decompression device at 40° C. and a pressure of 4.0×10³ Pa (30 torr) for 3 hours.

### 5. Production of Toner

### Production of Wax Dispersion Liquid

The resin obtained through <4. Washing of Polylactic Acid Resin> (5 parts by mass), a carnauba wax (5 parts by mass), and ethyl acetate (20 parts by mass) were mixed, and the mixture was heated to 85° C. so as to completely dissolve the carnauba wax. The resulting dispersion liquid was rapidly cooled with iced water and then dispersed with a bead mill (ULTRA VISCOMILL manufactured by Aimex Co., Ltd.) under the following conditions: liquid feed rate: 1 kg/hr, disc circumferential speed: 6 m/sec, 0.5 mm-zirconia bead filled at 80% by volume, and three passes, to thereby obtain a wax dispersion liquid.

### 6. Production of Toner

### Production of Toner Component Mixture Liquid

The wax dispersion liquid having a solid concentration of 14 parts by mass, produced through <5. Production of Toner>, and the resin obtained through <4. Washing of Polylactic Acid Resin> (80 parts by mass) were dispersed in ethyl acetate so that the solid concentration became 40% by mass. Further, a carbon black (Printex 35, produced by Degussa AG) (6 parts by mass) was added to the wax dispersion liquid, followed by three passes of a dispersion treatment similarly to the above using a bead mill, to thereby obtain a black colored resin solution.

### 7. Production of Toner

### Production of Emulsifier Aqueous Solution

Ion exchanged water containing 20% by mass of a nonionic surfactant NL450 (produced by Daiichi Kagaku Yakuhin Co. Ltd. was prepared.

Next, ethyl acetate (10 parts by mass) was added to this aqueous solution and stirred sufficiently.

### 8. Production of Toner

### Granulation

This aqueous solution obtained through <7. Production of Toner> was mixed with the resin solution obtained through <6. Production of Toner> at a mass ratio of 7:3, and the mixture was stirred by a homogenizer. As a result, a black colored resin dispersion liquid was obtained.

The resin solution was vaporized by an evaporator while being stirred, followed by removal of the ethyl acetate in the slurry.

The resulting slurry was subjected to centrifugal separation, and a washing treatment for substituting a supernatant fluid of the slurry with pure ion exchanged water was repeated 5 times. The resulting product was filtered to obtain a powder, and the powder was dried at 40° C. under reduced pressure.

### 9. Production of Toner

### Mixing of External Additives

A hydrophobic silica, R972D (produced by Nippon Aerosil Co., Ltd.) (1 part by mass) was added to the powder obtained through <8. Production of Toner> and stirred by a mixer to thereby obtain a toner.

The thus obtained toner had a weight average particle diameter of 6.2 μm.

### 10. Production of Carrier

Into toluene (100 parts by mass), a silicone resin (methyl silicone) (100 parts by mass), γ-(2-aminoethyl)aminopropyl trimethoxysilane (5 parts by mass), and carbon black (10 parts by mass) were added and dispersed by a homomixer for 20 minutes to prepare a resin layer coating solution. Using a fluidized-bed coating device, the resin layer coating liquid was applied to a surface of a spherical shape ferrite having a volume average particle diameter of 35 μm (1,000 parts by mass), to produce a carrier.

### 11. Production of Developer

The carrier obtained through <10. Production of Carrier> and the toner obtained through <9. Production of Toner> were mixed at a mass ratio of 93:7 to produce a developer.

### 12. Output of Image

The developer obtained through <11. Production of Developer> was loaded on a black developing unit of a color copier (IMAGIO MP C 4500, manufactured by Ricoh Company Ltd.), and an image was output.

As a result, an output image excellent in quality was obtained.

### Example 2

A toner was produced in the same manner as in Example 1, except that in <1. Hydrolysis of Waste Paper>, a virgin paper (RICOH TYPE T6200) was used instead of the waste paper serving as a raw material.

Similarly to the above, an image was output using the obtained toner. As a result, an output image excellent in quality was obtained.

What is claimed is:

1. A method for producing a toner, the method comprising:
1) saccharifying paper by at least one of a chemical degradation method and a biochemical degradation method to obtain a sugar-containing solution,
2) subjecting the sugar-containing solution obtained through 1) to lactic acid fermentation to obtain a lactic acid,
3) polymerizing the lactic acid obtained through 2) to obtain a polylactic acid, and
4) producing a toner using the polylactic acid obtained through 3).

2. The method for producing a toner according to claim 1, wherein the paper is a paper to which a toner is attached.

3. The method for producing a toner according to claim 1, wherein the paper is a waste paper.

4. A toner comprising:
a polylactic acid,
wherein the toner is produced by a toner production method which comprises:
1) saccharifying paper by at least one of a chemical degradation method and a biochemical degradation method to obtain a sugar-containing solution,
2) subjecting the sugar-containing solution obtained through 1) to lactic acid fermentation to obtain a lactic acid,
3) polymerizing the lactic acid obtained through 2) to obtain a polylactic acid, and
4) producing a toner using the polylactic acid obtained through 3).

5. A method for recycling paper, the method comprising:
1) saccharifying paper by at least one of a chemical degradation method and a biochemical degradation method to obtain a sugar-containing solution,
2) subjecting the sugar-containing solution obtained through 1) to lactic acid fermentation to obtain a lactic acid,
3) polymerizing the lactic acid obtained through 2) to obtain a polylactic acid, and
4) producing a toner using the polylactic acid obtained through 3).
